(19) United States
(12) Patent Application Publication
(10) Pub. No.: US 2022/0204790 A1
(43) Pub. Date: Jun. 30, 2022

(54) HIGH REFRACTIVE INDEX OVERCOAT FORMULATION AND METHOD OF USE WITH INKJET PRINTING

(71) Applicant: Facebook Technologies, LLC, Menlo Park, CA (US)

(72) Inventors: Keren ZHANG, Woodinville, WA (US); Ankit VORA, Bothell, WA (US); Igor ABRAMSON, Duvall, WA (US); Sara AZARI, Kirkland, WA (US)

(21) Appl. No.: 17/555,101

(22) Filed: Dec. 17, 2021

Related U.S. Application Data
(60) Provisional application No. 63/132,726, filed on Dec. 31, 2020.

(51) Int. Cl. C09D 11/38; C09D 11/106; B41M 5/00; B41M 3/00; F21V 8/00

(52) U.S. Cl. CPC C09D 11/38; C09D 11/106; B41M 5/0023; B41M 5/0088; G02B 6/0036; B41M 3/003; B41M 5/007; B41M 5/0058; G02B 6/0016; B41M 5/0047

(57) ABSTRACT

A formulation for inkjet printing includes one or more solvents and a plurality of nanoparticles mixed with the one or more solvents. The plurality of nanoparticles has a first refractive index greater than 1.9. A method includes depositing a layer of the formulation by inkjet printing onto a substrate having a non-flat. The method thereby forms coating of the formulation having a first surface conforming to the non-flat surface of the substrate and a second surface, opposite to the first surface, being a flat surface. An optical device includes a surface relief grating and a coating layer disposed on the surface relief grating. The coating layer includes a plurality of nanoparticles having a refractive index greater than 1.45 and a resin. The plurality of nanoparticles has functional ligands cross-linked with the resin.

### RELATED APPLICATIONS

This application is claims priority to U.S. Provisional Patent Application Ser. No. 63/132,726, filed Dec. 31, 2020, which is incorporated by reference herein in its entirety.

This application is related to U.S. patent application Ser. No. 16/778,492, filed Jan. 31, 2020 and U.S. patent application Ser. No. 16/779,446, filed Jan. 31, 2020, both of which are incorporated by reference herein in their entireties.

### FIELD

This application relates generally to a formulation that can be deposited by inkjet printing, and particularly to a formulation having a high refractive index that can be used as an overcoat for optical components.

### BACKGROUND

An artificial reality system, such as a head-mounted display (HMD) or heads-up display (HUD) system, generally includes a near-eye display (e.g., a headset or a pair of glasses) configured to present content to a user via an electronic or optical display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

An AR system may use a waveguide-based optical display, where light of projected images may be coupled into a waveguide (e.g., a substrate), propagate within the waveguide, and be coupled out of the waveguide at different locations. In some implementations, the light of the projected images may be coupled into or out of the waveguide using a diffractive optical element, such as a slanted surface-relief grating. To achieve desired performance, such as high efficiency, low artifact, and angular selectivity, deep surface-relief gratings with large slanted angles and wide ranges of grating duty cycles may be used.

An overcoat material can significantly improve the overall waveguide performance by reducing the light leakage and provide gap-fill and planarization for the gratings. In addition, an overcoat layer can protect the grating from physical damage and improve waveguide optical performances, such as increased throughput, enhanced spatial uniformity, and reduced leakage. However, conventional overcoat layers do not have sufficient performance.

### SUMMARY

The challenges associated with conventional overcoat layers are addressed by the formulations, methods, and devices disclosed herein.

In this application, a formulation with refractive index higher than 1.9, high transparency to visible light, and low optical loss that is compatible with inkjet printing is disclosed. The formulation allows formation of an optical film having the refractive index higher than 1.9. Inkjet printing provides a uniform overburden on gratings with various duty cycles and heights.

In accordance with some embodiments, a formulation for inkjet printing includes one or more solvents and a plurality of nanoparticles having a first refractive index. The formulation also includes a resin having a second refractive index ranging from 1.45 to 1.8. The first refractive index is greater than the second refractive index.

In some embodiments, a coating made of the formulation has a refractive index greater than 1.9. In some embodiments, the coating has an optical loss less than 1%.

In some embodiments, the plurality of nanoparticles has functional ligands cross-linkable with the resin.

In some embodiments, the functional ligands are selected from a group consisting of epoxy, acrylate, vinyl, thiol, phenol, and hydroxyl.

In some embodiments, the second refractive index ranges from 1.6 to 1.8.

In some embodiments, the resin includes one or more of: an electromagnetic radiation-sensitive material, a light-sensitive material, or a heat-sensitive material.

In some embodiments, the resin further includes one or more of a thermal radical initiator, a thermal acid generator, a photo radical generator, and a photo acid generator.

In some embodiments, the resin includes one or more of: monomers or polymers.

In some embodiments, the plurality of nanoparticles includes titanium oxide nanoparticles.

In some embodiments, the one or more solvents include at least one solvent having a boiling point above 150° Celsius or a vapor pressure below 2.8 mmHg at 20° Celsius.

In some embodiments, the one or more solvents are selected from a group consisting of: propylene glycol methyl ether acetate, anisole, cyclohexanone, propylene carbonate, di(propylene glycol) butyl ether, di(propylene glycol) methyl ether, di(propylene glycol) dimethyl ether, di(propylene glycol) methyl ether acetate, butyl lactate, 2-ethylhexyl-lactate, benzyl benzoate, N-methyl-2-pyrrolidinone, gamma-butyrolactone, tripropylene glycol methylether, 1,6-diacetoxyhexane, 3-phenoxy toluene, benzyl alcohol, tolyl ether, and tripropylene glycol dimethyl ether.

In some embodiments, the formulation further includes one or more additives, a respective additive of the one or more additives including one or more monomers and/or polymers containing phosphonic acid or one or more aromatic groups with a hydroxyl, acid, alkyl ether, or alkyl ester functional group.

In some embodiments, the one or more additives include an additive selected from a group consisting of: poly(4-vinylphenol), poly(acetoxystyrene), poly(methoxystyrene), poly(di-acetoxystyrene), poly(di-methoxystyrene), cresol novolac, catechol novolac, phthalic acid, 3-methylcatechol, caffeic acid, eugenol, and vinyl-phosphonic acid.

In some embodiments, the formulation has a viscosity ranging from 2 to 16 cP.

In some embodiments, the formulation has a surface tension ranging from 20 to 50 Dynes/cm.

In some embodiments, a percentage of a solid material in the formulation ranges from 0.1% to 60%.

In accordance with some embodiments, a method includes depositing a first amount of the formulation described herein through one or more inkjet nozzles onto a first portion of a substrate having a non-flat surface and a second amount of the formulation through the one or more inkjet nozzles onto a second portion of the substrate having the non-flat surface. The first portion of the non-flat surface is distinct from the second portion of the non-flat surface and the first amount of the formulation is distinct from the second amount of the formulation.

In some embodiments, depositing the first amount of the formulation and the second amount of the formulation thereby forms a coating of the formulation having a first surface conforming to the non-flat surface of the substrate and a second surface, opposite to the first surface, being a flat surface.

In some embodiments, the substrate is selected from a group consisting of TiOx, Si, SiOx, SiN, NbO, SiC, LiNbO3, and glass.

In accordance with some embodiments, an optical device includes a surface relief grating and a coating layer having a refractive index higher than 1.9 disposed on the surface relief grating. The coating layer includes a plurality of nanoparticles and a crosslinkable resin. having a refractive index and a resin. The plurality of nanoparticles has functional ligands cross-linked with the resin. In some embodiments, the plurality of nanoparticles has a first refractive index and the resin has a second refractive index (e.g., ranging from 1.45 to 1.8) and the first refractive index is greater than the second refractive index.

### BRIEF DESCRIPTION OF DRAWINGS

For a better understanding of the various described embodiments, reference should be made to the Description of Embodiments below, in conjunction with the following drawings in which like reference numerals refer to corresponding parts throughout the figures.

FIGS. 1 and 2 are photographs of TiO₂ substrates coated with formulations in accordance with some embodiments.

FIG. 3 is a schematic diagram illustrating deposition of a coating formulation using an inkjet in accordance with some embodiments.

FIG. 4 is a flow diagram illustrating a method of depositing a formulation using an inkjet nozzle in accordance with some embodiments.

FIG. 5 is a perspective view of a display device in accordance with some embodiments.

FIG. 6 is a block diagram of a system including a display device in accordance with some embodiments.

FIG. 7A is an isometric view of a display device in accordance with some embodiments.

FIG. 7B is a schematic diagram illustrating a display device in accordance with some embodiments.

These figures are not drawn to scale unless indicated otherwise.

### DETAILED DESCRIPTION

### Definitions

Unless defined otherwise, all technical and scientific terms used herein have the same meaning as is commonly understood by one of skill in the art to which this disclosure belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

Unless otherwise stated, the chemical structures depicted herein are intended to include compounds which differ only in the presence of one or more isotopically enriched atoms. For example, compounds where one or more hydrogen atoms is replaced by deuterium or tritium, or where one or more carbon atoms is replaced by ¹³C- or ¹⁴C-enriched carbons, are within the scope of this disclosure.

“Alkyl” refers to a straight or branched hydrocarbon chain radical consisting solely of carbon and hydrogen atoms, containing no unsaturation, having from one to ten carbon atoms (e.g., (C₁₋₁₀)alkyl or C₁₋₁₀ alkyl). Whenever it appears herein, a numerical range such as “1 to 10” refers to each integer in the given range—e.g., “1 to 10 carbon atoms” means that the alkyl group may consist of 1 carbon atom, 2 carbon atoms, 3 carbon atoms, etc., up to and including 10 carbon atoms, although the definition is also intended to cover the occurrence of the term “alkyl” where no numerical range is specifically designated. Typical alkyl groups include, but are in no way limited to, methyl, ethyl, propyl, isopropyl, n-butyl, isobutyl, sec-butyl isobutyl, tertiary butyl, pentyl, isopentyl, neopentyl, hexyl, septyl, octyl, nonyl and decyl. The alkyl moiety may be attached to the rest of the molecule by a single bond, such as for example, methyl (Me), ethyl (Et), n-propyl (Pr), 1-methylethyl (isopropyl), n-butyl, n-pentyl, 1,1-dimethylethyl (t-butyl) and 3-methylhexyl. Unless stated otherwise specifically in the specification, an alkyl group is optionally substituted by one or more of substituents which are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

“Alkylaryl” refers to an -(alkyl)aryl radical where aryl and alkyl are as disclosed herein and which are optionally substituted by one or more of the substituents described as suitable substituents for aryl and alkyl respectively.

“Alkylhetaryl” refers to an -(alkyl)hetaryl radical where hetaryl and alkyl are as disclosed herein and which are optionally substituted by one or more of the substituents described as suitable substituents for aryl and alkyl respectively.

“Alkylheterocycloalkyl” refers to an -(alkyl) heterocyclyl radical where alkyl and heterocycloalkyl are as disclosed herein and which are optionally substituted by one or more of the substituents described as suitable substituents for heterocycloalkyl and alkyl respectively.

An “alkene” moiety refers to a group consisting of at least two carbon atoms and at least one carbon-carbon double bond, and an “alkyne” moiety refers to a group consisting of at least two carbon atoms and at least one carbon-carbon triple bond. The alkyl moiety, whether saturated or unsaturated, may be branched, straight chain, or cyclic.

“Alkenyl” refers to a straight or branched hydrocarbon chain radical group consisting solely of carbon and hydrogen atoms, containing at least one double bond, and having from two to ten carbon atoms (e.g., (C₂₋₁₀)alkenyl or C₂₋₁₀ alkenyl). Whenever it appears herein, a numerical range such as “2 to 10” refers to each integer in the given range—e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (e.g., vinyl), prop-1-enyl (e.g., allyl), but-1-enyl, pent-1-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkenyl-cycloalkyl” refers to an -(alkenyl)cycloalkyl radical where alkenyl and cycloalkyl are as disclosed herein and which are optionally substituted by one or more of the substituents described as suitable substituents for alkenyl and cycloalkyl respectively.

“Amino” or “amine” refers to a —N(R^{a})₂ radical group, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two R^{a} substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a},—SR^{a}, —OC(O)—R^{a}, —N(R^{a})₂, —C(O)R^{a}, —C(O)OR^{a}, —C(O)SR^{a}, —SC(O)R^{a},—OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{d}, and NR^{d}R^{d} each as described above. N-oxides can be prepared by treatment of the corresponding amino group with, for example, hydrogen peroxide or m-chloroperoxybenzoic acid.

“Aromatic” or “aryl” or “Ar” refers to an aromatic radical with six to ten ring atoms (e.g., C₆-C₁₀ aromatic or C₆-C₁₀ aryl) which has at least one ring having a conjugated pi electron system which is carbocyclic (e.g., phenyl, fluorenyl, and naphthyl). Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” refers to each integer in the given range; e.g., “6 to 10 ring atoms” means that the aryl group may consist of 6 ring atoms, 7 ring atoms, etc., up to and including 10 ring atoms. The term includes monocyclic or fused-ring polycyclic (e.g., rings which share adjacent pairs of ring atoms) groups. Unless stated otherwise specifically in the specification, an aryl moiety is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl. It is understood that a substituent R attached to an aromatic ring at an unspecified position,

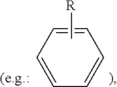

includes one or more, and up to the maximum number of possible substituents.

The term “aryloxy” refers to the group —O-aryl.

The term “substituted aryloxy” refers to aryloxy where the aryl substituent is substituted (e.g., —O-(substituted aryl)). Unless stated otherwise specifically in the specification, the aryl moiety of an aryloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —OC(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Aralkyl” or “arylalkyl” refers to an (aryl)alkyl-radical where aryl and alkyl are as disclosed herein and which are optionally substituted by one or more of the substituents described as suitable substituents for aryl and alkyl respectively.

“Ester” refers to a chemical radical of formula —COOR, where R is selected from the group consisting of alkyl, cycloalkyl, aryl, heteroaryl (bonded through a ring carbon) and heteroalicyclic (bonded through a ring carbon). The procedures and specific groups to make esters are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety. Unless stated otherwise specifically in the specification, an ester group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Fluoroalkyl” refers to an alkyl radical, as defined above, that is substituted by one or more fluoro radicals, as defined above, for example, trifluoromethyl, difluoromethyl, 2,2,2-trifluoroethyl, 1-fluoromethyl-2-fluoroethyl, and the like. The alkyl part of the fluoroalkyl radical may be optionally substituted as defined above for an alkyl group.

“Halo,” “halide,” or, alternatively, “halogen” is intended to mean fluoro, chloro, bromo or iodo. The terms “haloalkyl,” “haloalkenyl,” “haloalkynyl,” and “haloalkoxy” include alkyl, alkenyl, alkynyl and alkoxy structures that are substituted with one or more halo groups or with combinations thereof. For example, the terms “fluoroalkyl” and “fluoroalkoxy” include haloalkyl and haloalkoxy groups, respectively, in which the halo is fluorine.

“Heteroalkyl,” “heteroalkenyl,” and “heteroalkynyl” refer to optionally substituted alkyl, alkenyl and alkynyl radicals and which have one or more skeletal chain atoms selected from an atom other than carbon, e.g., oxygen, nitrogen, sulfur, phosphorus or combinations thereof. A numerical range may be given—e.g., C₁-C₄ heteroalkyl which refers to the chain length in total, which in this example is 4 atoms long. A heteroalkyl group may be substituted with one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)(O)R^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heteroalkylaryl” refers to an -(heteroalkyl)aryl radical where heteroalkyl and aryl are as disclosed herein and which are optionally substituted by one or more of the substituents described as suitable substituents for heteroalkyl and aryl, respectively.

“Heteroalkylheteroaryl” refers to an -(heteroalkyl)heteroaryl radical where heteroalkyl and heteroaryl are as disclosed herein and which are optionally substituted by one or more of the substituents described as suitable substituents for heteroalkyl and heteroaryl, respectively.

“Heteroalkylheterocycloalkyl” refers to an -(heteroalkyl)heterocycloalkyl radical where heteroalkyl and heterocycloalkyl are as disclosed herein and which are optionally substituted by one or more of the substituents described as suitable substituents for heteroalkyl and heterocycloalkyl, respectively.

“Heteroalkylcycloalkyl” refers to an -(heteroalkyl)cycloalkyl radical where heteroalkyl and cycloalkyl are as disclosed herein and which are optionally substituted by one or more of the substituents described as suitable substituents for heteroalkyl and cycloalkyl, respectively.

“Heteroaryl” or “heteroaromatic” or “HetAr” refers to a 5- to 18-membered aromatic radical (e.g., C₅-C₁₃ heteroaryl) that includes one or more ring heteroatoms selected from nitrogen, oxygen and sulfur, and which may be a monocyclic, bicyclic, tricyclic or tetracyclic ring system. Whenever it appears herein, a numerical range such as “5 to 18” refers to each integer in the given range—e.g., “5 to 18 ring atoms” means that the heteroaryl group may consist of 5 ring atoms, 6 ring atoms, etc., up to and including 18 ring atoms. Bivalent radicals derived from univalent heteroaryl radicals whose names end in “-yl” by removal of one hydrogen atom from the atom with the free valence are named by adding “-idene” to the name of the corresponding univalent radical—e.g., a pyridyl group with two points of attachment is a pyridylidene. A N-containing “heteroaromatic” or “heteroaryl” moiety refers to an aromatic group in which at least one of the skeletal atoms of the ring is a nitrogen atom. The polycyclic heteroaryl group may be fused or non-fused. The heteroatom(s) in the heteroaryl radical are optionally oxidized. One or more nitrogen atoms, if present, are optionally quaternized. The heteroaryl may be attached to the rest of the molecule through any atom of the ring(s). Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo-[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7, 8-tetrahydroquinazolinyl, 5,6,7, 8-tetrahydrobenzo[4,5]thieno[2,3 -d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (e.g., thienyl). Unless stated otherwise specifically in the specification, a heteroaryl moiety is optionally substituted by one or more substituents which are independently: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —(O)C(O)—R^{a}, —N(R^{a})₂, —C(O)R^{a}, —C(O)OR^{a}, —C(O)SR^{a}, —SC(O)R^{a}, —(O)C(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

Substituted heteroaryl also includes ring systems substituted with one or more oxide (—O—) substituents, such as, for example, pyridinyl N-oxides.

“Heteroarylalkyl” refers to a moiety having an aryl moiety, as described herein, connected to an alkylene moiety, as described herein, where the connection to the remainder of the molecule is through the alkylene group.

“Heterocycloalkyl” refers to a stable 3- to 18-membered non-aromatic ring radical that comprises two to twelve carbon atoms and from one to six heteroatoms selected from nitrogen, oxygen and sulfur. Whenever it appears herein, a numerical range such as “3 to 18” refers to each integer in the given range—e.g., “3 to 18 ring atoms” means that the heterocycloalkyl group may consist of 3 ring atoms, 4 ring atoms, etc., up to and including 18 ring atoms. Unless stated otherwise specifically in the specification, the heterocycloalkyl radical is a monocyclic, bicyclic, tricyclic or tetracyclic ring system, which may include fused or bridged ring systems. The heteroatoms in the heterocycloalkyl radical may be optionally oxidized. One or more nitrogen atoms, if present, are optionally quaternized. The heterocycloalkyl radical is partially or fully saturated. The heterocycloalkyl may be attached to the rest of the molecule through any atom of the ring(s). Examples of such heterocycloalkyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocycloalkyl moiety is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —(O)C(O)—R^{a}, —N(R^{a})₂, —C(O)R^{a}, —C(O)OR^{a}, —C(O)SRa, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heterocycloalkyl” also includes bicyclic ring systems where one non-aromatic ring, usually with 3 to 7 ring atoms, contains at least 2 carbon atoms in addition to 1-3 heteroatoms independently selected from oxygen, sulfur, and nitrogen, as well as combinations including at least one of the foregoing heteroatoms; and the other ring, usually with 3 to 7 ring atoms, optionally contains 1-3 heteroatoms independently selected from oxygen, sulfur, and nitrogen and is not aromatic.

“Nitro” refers to the —NO₂ radical.

“Oxa” refers to the —O-radical.

“Oxo” refers to the ═O radical.

“Isomers” are different compounds that have the same molecular formula. “Stereoisomers” are isomers that differ only in the way the atoms are arranged in space—e.g., having a different stereochemical configuration. “Enantiomers” are a pair of stereoisomers that are non-superimposable mirror images of each other. A 1:1 mixture of a pair of enantiomers is a “racemic” mixture. The term “(±)” is used to designate a racemic mixture where appropriate. “Diastereoisomers” are stereoisomers that have at least two asymmetric atoms, but which are not mirror-images of each other. The absolute stereochemistry is specified according to the Cahn-Ingold-Prelog R-S system. When a compound is a pure enantiomer the stereochemistry at each chiral carbon can be specified by either (R) or (S). Resolved compounds whose absolute configuration is unknown can be designated (+) or (−) depending on the direction (dextro- or levorotatory) which they rotate plane polarized light at the wavelength of the sodium D line. Certain of the compounds described herein contain one or more asymmetric centers and can thus give rise to enantiomers, diastereomers, and other stereoisomeric forms that can be defined, in terms of absolute stereochemistry, as (R) or (S). The present chemical entities, compositions and methods are meant to include all such possible isomers, including racemic mixtures, optically pure forms and intermediate mixtures. Optically active (R)- and (S)-isomers can be prepared using chiral synthons or chiral reagents, or resolved using conventional techniques. When the compounds described herein contain olefinic double bonds or other centers of geometric asymmetry, and unless specified otherwise, it is intended that the compounds include both E and Z geometric isomers.

“Moiety” refers to a specific segment or functional group of a molecule. Chemical moieties are often recognized chemical entities embedded in or appended to a molecule.

“Solvate” refers to a compound in physical association with one or more molecules of a pharmaceutically acceptable solvent.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono- and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

Compounds of the present disclosure also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, diseases, formulae, compounds or groups) described in conjunction with a particular aspect, embodiment or example of the disclosure are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The present disclosure is not restricted to any details of any disclosed embodiments. The present disclosure extends to any novel one, or novel combination, of the features disclosed in this specification (including any accompanying claims, abstract and drawings), or to any novel one, or any novel combination, of the steps of any method or process so disclosed.

### Formulation

Disclosed herein is a formulation that can form an overcoat layer suitable for use with a surface-relief grating. The overcoat layer may i) have a high refractive index to pair with the grating materials, ii) allow a uniform overburden on top of a grating with various duty cycles and heights across mm in distance, which enables a combination of a surface relief grating with an overcoat layer that satisfies throughput, uniformity, and leakage requirements, and/or iii) allow exclusion of an overcoat material over some areas of the waveguide such as input gratings.

Physical vapor deposition (PVD), chemical vapor deposition (CVD), and atomic layer deposition (ALD) are commonly used deposition techniques to fabricate nanometer-thick thin film with various refractive indexes. However, these deposition techniques generally apply a uniform thickness layer that is contoured to the surface, which will lead to pin holes in the low duty circle areas. Spatial control also requires extra processing steps, which leads to defects, error and high cost. Spin coating is a widely used coating process to achieve uniform coating with nanometer to micron thickness with better gap fill capability than deposition techniques. However, planarizing flow driven by surface tension typically covers 1-100 microns in distance for a nanometer-thick film (e.g., a film having a thickness between 1 nm and 10 nm). It is challenging to achieve long-range planarization across a millimeter distance with a spin-on process. Inkjet printing allows programmable deposition of coating volumes on demand, applying various amounts of ink according to the grating design to achieve gap fill and uniform overburden on varying gratings.

In some embodiments, a formulation has a high refractive index and a high transparency to visible light, and is compatible with inkjet printing techniques. In some embodiments, the inkjet printing techniques include UV-inkjet printing techniques. In some embodiments, an overcoat of the formulation is applied on a flat substrate or surface-relief structures, such as a patterned substrate with slanted or non-slanted surface-relief gratings used in a near-eye display system.

In some embodiments, a cross-linkable formulation for inkjet printing includes a base resin component having a second refractive index ranging from 1.45 to 1.80, and a nanoparticles component having a first refractive index greater than the second refractive index of the base resin component.

In some embodiments, the first refractive index ranges from 1.50 to 2.61. In some embodiments, the first refractive index is selected from about 1.50, about 1.55, about 1.60, about 1.65, about 1.70, about 1.75, about 1.80, about 1.85, about 1.90, and about 1.95. In some embodiments, the first refractive index ranges from 1.60 to 2.61. In some embodiments, the first refractive index ranges from 1.70 to 2.61. In some embodiments, the first refractive index ranges from 1.80 to 2.61. In some embodiments, the first refractive index ranges from 1.90 to 2.61.

In some embodiments, the first refractive index ranges from 2.00 to 2.61. In some embodiments, the first refractive index is selected from about 2.00, about 2.01, about 2.02, about 2.03, about 2.04, about 2.05, about 2.06, about 2.07, about 2.08, about 2.09, about 2.10, about 2.11, about 2.12, about 2.13, about 2.14, about 2.15, about 2.16, about 2.17, about 2.18, 2.19, about 2.20, about 2.21, about 2.22, about 2.23, about 2.24, about 2.25, about 2.26, about 2.27, about 2.28, about 2.29, about 2.30, about 2.31, about 2.32, about 2.33, about 2.34, about 2.35, about 2.36, about 2.37, about 2.38, about 2.39, about 2.40, about 2.41, about 2.42, about 2.43, about 2.44, about 2.45, about 2.46, about 2.47, about 2.48, about 2.49, about 2.50, about 2.51, about 2.52, about 2.53, about 2.54, about 2.55, about 2.56, about 2.57, about 2.58, about 2.59, about 2.60, and about 2.61.

In some embodiments, the formulation also includes one or more additives with one or more polar functional groups, and a solvent system with one or more solvents with boiling point higher than 150° Celsius or vapor pressure lower than 2.8 mmHg at 20° Celsius. In some embodiments, the base resin component is UV curable. In some embodiments, the base resin component is thermally curable. In some embodiments, the final overcoat has a refractive index higher than 1.9 at 520 nm and lower than 1.0% single pass optical loss at 460 nm (e.g., for an overcoat having a 200 nm thickness). In some embodiments, the optical loss at 460 nm is lower than 0.5%.

In some embodiments, the formulation includes metal oxide precursors for inkjet printing of an overcoat on a flat substrate or a patterned substrate. After curing (e.g., by exposure to UV light or heat or both), the overcoat film has a high refractive index (e.g., a refractive index above 1.9) and high transparency to visible light.

In some embodiments, a method of applying the formulation includes depositing the formulation with one or more inkjet printers on a substrate with or without gratings, which may be slanted or non-slanted. In some embodiments, the substrate is made of a material selected from a group consisting of TiOx, Si, SiOx, SiN, NbO, LiNbO3, SiC, or glass. In some embodiments, the substrate is made of a combination of two or more materials selected from the group. In some embodiments, the substrate is pretreated with plasma ash cleaning, SC1 or SC2 cleaning, ozone cleaning, dehydration bake, an adhesion layer, or any combination thereof. In some embodiments, the adhesion layer includes an organic material or an inorganic material (e.g., Si-containing coating or metal coating). In some cases, the substrate pretreatment is used for better wetting of ink formulation or improved adhesion to the substrate.

In some embodiments, the nanoparticles include titanium oxide (TiOx) nanoparticles, niobium oxide (NbOx) nanoparticles, zirconium nanoparticles (ZrOx), or a combination thereof. In some embodiments, the nanoparticles include nanoparticle cores (e.g., the TiOx nanoparticle contains a TiOx core) with one or more crosslinkable or polymerizable functional groups. In some embodiments, the nanoparticle core (e.g., TiOx nanoparticle core) has a refractive index greater than 2, greater than 2.1, greater than 2.2, greater than 2.3, greater than 2.4, or greater than 2.5. In some embodiments, the one or more crosslinkable or polymerizable functional groups are linked to the substantially inorganic core. In some embodiments, the one or more functional groups include one or more of epoxy, acrylate, vinyl, thiol, phenol, or hydroxyl groups. In some embodiments, the one or more crosslinkable or polymerizable functional groups include one or more of an ethylenically unsaturated group, an oxirane ring, or a heterocyclic group. In some embodiments, the crosslinkable or polymerizable moieties include one or more of vinyl, allyl, epoxide, acrylate, and methacrylate. In some embodiments, the crosslinkable or polymerizable moieties include one or more of optionally substituted alkenyl, optionally substituted cycloalkenyl, optionally substituted alkynyl, optionally substituted acrylate, optionally substituted methacrylate, optionally substituted styrene, optionally substituted epoxide, optionally substituted thiirane, optionally substituted lactone, and optionally substituted carbonate. In some embodiments, the crosslinkable or polymerizable moieties include one or more linking groups selected from —Si(—O—)₃, -C₁₋₁₀ alkyl-, —O-C₁₋₁₀ alkyl-, -C₁₋₁₀ alkenyl-, —O—C₁₋₁₀ alkenyl-, -C₁₋₁₀ cycloalkenyl-, —O—C₁₋₁₀ cycloalkenyl-, -C₁₋₁₀ alkynyl-, —O-C₁₋₁₀ alkynyl-, -C₁₋₁₀ aryl-, —O-C₁₋₁₀-, -aryl-, —O—, —S—, —C(O)—, —C(O)O—, —OC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, where w is 1 or 2, and R^{b} is independently hydrogen, optionally substituted alkyl, or optionally substituted aryl.

In some embodiments, the diameter of the nanoparticle core ranges from about 1 nm to about 25 nm. In some embodiments, the diameter of the nanoparticle core is selected from about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, and about 25 nm. In some embodiments, the diameter of the nanoparticle core is measured by transmission electron microscopy (TEM).

In some embodiments, the diameter of the nanoparticle core ranges from about 5 nm to about 100 nm. In some embodiments, the diameter of the nanoparticle core ranges from about 10 nm to about 50 nm. In some embodiments, the diameter of the nanoparticle core is selected from about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, and about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, about 50 nm, about 51 nm, about 52 nm, about 53 nm, about 54 nm, about 55 nm, about 56 nm, about 57 nm, about 58 nm, about 59 nm, about 60 nm, about 61 nm, about 62 nm, about 63 nm, about 64 nm, about 65 nm, about 66 nm, about 67 nm, about 68 nm, about 69 nm, about 70 nm, about 71 nm, about 72 nm, about 73 nm, about 74 nm, about 75 nm, about 76 nm, about 77 nm, about 78 nm, about 79 nm, about 80 nm, about 81 nm, about 82 nm, about 83 nm, about 84 nm, about 85 nm, about 86 nm, about 87 nm, about 88 nm, about 89 nm, about 90 nm, about 91 nm, about 92 nm, about 93 nm, about 94 nm, about 95 nm, about 96 nm, about 97 nm, about 98 nm, about 99 nm, and about 100 nm. In some embodiments, the diameter of the nanoparticle core is measured by dynamic light scattering (DLS).

In some embodiments, the one or more solvents include propylene glycol methyl ether acetate, anisole, cyclohexanone, propylene carbonate, di(propylene glycol) butyl ether, di(propylene glycol) methyl ether, di(propylene glycol) dimethyl ether, di(propylene glycol) methyl ether acetate, butyl lactate, 2-ethylhexyl-lactate, benzyl benzoate, N-methyl-2-pyrrolidinone, gamma-butyrolactone, tripropylene glycol methylether, 1,6-diacetoxyhexane, 3-phenoxy toluene, benzyl alcohol, tolyl ether, tripropylene glycol dimethyl ether or any combination thereof. In some embodiments, the one or more solvents include at least one solvent with a boiling point above 150° Celsius or a vapor pressure below 2.8 mmHg at 20° Celsius. In some embodiments, the one or more solvents include at least one solvent with a boiling point above 180° Celsius or a vapor pressure below 2.8 mmHg at 20° Celsius. In some embodiments, the one or more solvents include at least 10% in volume a solvent with a boiling point above 180° Celsius.

In some embodiments, the base resin component includes one or more resins. In some embodiments, the one or more resins include a resin having a refractive index ranging between 1.45 and 1.8. In some embodiments, the one or more resins include a resin having a refractive index ranging between 1.5 and 1.8, between 1.5 and 1.75, between 1.6 and 1.8, or between 1.7 and 1.8. In some embodiments, the refractive index ranges from 1.52 to 1.73. In some embodiments, the refractive index ranges from 1.52 to 1.71. In some embodiments, the refractive index ranges from 1.52 to 1.70. In some embodiments, the refractive index ranges from 1.55 to 1.77. In some embodiments, the refractive index ranges from 1.58 to 1.77. In some embodiments, the refractive index ranges from 1.55 to 1.73. In some embodiments, the refractive index ranges from 1.50 to 1.73. In some embodiments, the refractive index ranges from 1.58 to 1.73. In some embodiments, the refractive index ranges from 1.60 to 1.77. In some embodiments, the refractive index ranges from 1.60 to 1.73. In some embodiments, the refractive index ranges from 1.50 to 1.80, from 1.55 to 1.80, from 1.57 to 1.80, from 1.58 to 1.77, from 1.58 to 1.70, or from 1.60 to 1.70. In some embodiments, the refractive index is selected from about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, and about 1.77. In some embodiments, the refractive index is measured at 589 nm. In some embodiments, the base resin component is light-sensitive. In some embodiments, the base resin component is heat sensitive. In some embodiments, the base resin includes an initiator (e.g., thermal radical initiator, thermal acid generator, photo radical generator, or photo acid generator and/or a combination thereof) and/or a polymerizable material (e.g., a monomer, polymer, and/or a combination thereof).

In some embodiments, the base resin component has a viscosity ranging from 0.5 cps to 400 cps. In some embodiments, the base resin component has a viscosity ranging from 2 cps to 100 cps. In some embodiments, the base resin component has a viscosity ranging from 10 cps to 100 cps. In some embodiments, the base resin component has a viscosity ranging from 10 cps to 60 cps. In some embodiments, the base resin component has a viscosity selected from about 1 cps, about 2 cps, about 3 cps, about 4 cps, about 5 cps, about 6 cps, about 7 cps, about 8 cps, about 9 cps, about 10 cps, about 11 cps, about 12 cps, about 13 cps, about 14 cps, about 15 cps, about 16 cps, about 17 cps, about 18 cps, about 19 cps, about 20 cps, about 21 cps, about 22 cps, about 23 cps, about 24 cps, about 25 cps, about 26 cps, about 27 cps, about 28 cps, about 29 cps, about 30 cps, about 31 cps, about 32 cps, about 33 cps, about 34 cps, about 35 cps, about 36 cps, about 37 cps, about 38 cps, about 39 cps, about 40 cps, about 41 cps, about 42 cps, about 43 cps, about 44 cps, about 45 cps, about 46 cps, about 47 cps, about 48 cps, about 49 cps, about 50 cps, about 51 cps, about 52 cps, about 53 cps, about 54 cps, about 55 cps, about 56 cps, about 57 cps, about 58 cps, about 59 cps, and about 60 cps. In some embodiments, the viscosity is measured in the absence of the nanoparticles component. In some embodiments, the viscosity is measured in the absence of a solvent. In some embodiments, the base resin component is a liquid at room temperature. In some embodiments, room temperature is considered between 15 and 25° C. In some embodiments, the base resin component is a liquid at a temperature between 20 and 25° C.In some embodiments, the base resin component comprises one or more crosslinkable monomers, one or more polymerizable monomers, or both. In some embodiments, the crosslinkable monomers or the polymerizable monomers include one or more crosslinkable or polymerizable moieties. In some embodiments, the crosslinkable or polymerizable moieties are selected from an ethylenically unsaturated group, an oxirane ring, and a heterocyclic group. In some embodiments, the crosslinkable or polymerizable moieties are selected from vinyl, allyl, epoxide, acrylate, and methacrylate. In some embodiments, the crosslinkable or polymerizable moieties are selected from optionally substituted alkenyl, optionally substituted cycloalkenyl, optionally substituted alkynyl, optionally substituted acrylate, optionally substituted methacrylate, optionally substituted styrene, optionally substituted epoxide, optionally substituted thiirane, optionally substituted lactone, and optionally substituted carbonate. In some embodiments, the crosslinkable or polymerizable moieties are selected from:

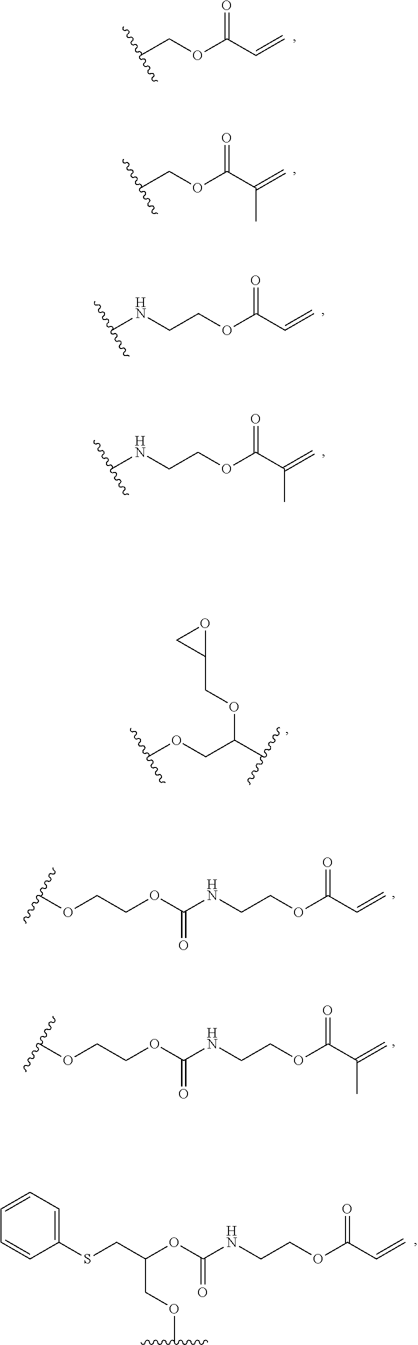

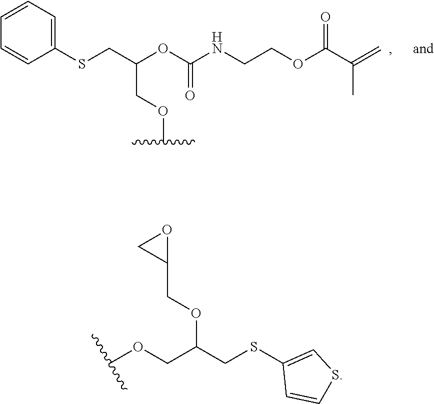 [SMILES: *OCC(CSc1ccccc1)OC(=O)NCCOC(=O)C(=C)C ; *OCC(CSc1ccsc1)OCC1CO1]

In some embodiments, the crosslinkable monomers or the polymerizable monomers include one or more moieties selected from optionally substituted alkyl, optionally substituted heteroalkyl, optionally substituted alkenyl, optionally substituted alkynyl, optionally substituted cycloalkyl, optionally substituted heterocycloalkyl, optionally substituted aryl, optionally substituted arylalkyl, optionally substituted heteroaryl, and optionally substituted heteroarylalkyl.

In some embodiments, the crosslinkable monomers or the polymerizable monomers include one or more moieties selected from fluorene, cardo fluorene, spiro fluorene, thianthrene, thiophosphate, anthraquinone, and lactam. In some embodiments, the crosslinkable monomers or the polymerizable monomers include one or more linking groups selected from -C₁₋₁₀ alkyl-, —O-C₁₋₁₀ alkyl-, -C₁₋₁₀ alkenyl-, —O-C₁₋₁₀ alkenyl-, -C₁₋₁₀ cycloalkenyl-, —O-C₁₋₁₀ cycloalkenyl-, -C₁₋₁₀ alkynyl-, —O-C₁₋₁₀ alkynyl-, -C₁₋₁₀ aryl-, —O-C₁₋₁₀-, -aryl-, —O—, —S—, —C(O)—, —C(O)O—, —(O)C(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, where w is 1 or 2, and R^{b} is independently hydrogen, optionally substituted alkyl, or optionally substituted aryl.

In some embodiments, the crosslinkable monomers or the polymerizable monomers include one or more terminal groups selected from optionally substituted thiophenyl, optionally substituted thiopyranyl, optionally substituted thienothiophenyl, and optionally substituted benzothiophenyl. In some embodiments, the base resin component includes one or more derivatives of bisfluorene, dithiolane, thianthrene, biphenol, o-phenylphenol, phenoxy benzyl, bisphenol A, bisphenol F, benzyl, or phenol. In some embodiments, the base resin component includes one or more of (2,7-bis[(2-acryloyloxyethl)-sulfanyl]thianthrene), benzyl methacrylate, 1,6-hexanediol diacrylate, 1,4-butanediol diacrylate, acryloxypropylsilsesquioxane, or methylsilsesquioxane.

In some embodiments, the base resin component includes one or more of trimethylolpropane (EO)n triacrylate, caprolactone acrylate, polypropylene glycol monomethacrylate, cyclic trimethylolpropane formal acrylate, phenoxy benzyl acrylate, 3,3,5-trimethyl cyclohexyl acrylate, isobornyl acrylate, o-phenylphenol EO acrylate, 4-tert-butylcyclohexyl acrylate, benzyl acrylate, benzyl methacrylate, biphenylmethyl acrylate, lauryl acrylate, lauryl methacrylate, tridecyl acrylate, lauryl tetradecyl methacrylate, isodecyl acrylate, isodecyl methacrylate, phenol (EO) acrylate, phenoxyethyl methacrylate, phenol (EO)2 acrylate, phenol (EO)4 acrylate, tetrahydrofurfuryl acrylate, tetrahydrofurfuryl methacrylate, nonyl phenol (PO)2 acrylate, nonyl phenol (EO)4 acrylate, nonyl phenol (EO)8 acrylate, ethoxy ethoxy ethyl acrylate, stearyl acrylate, stearyl methacrylate, methoxy PEG600 methacrylate, 1,6-hexanediol diacrylate, 1,6-hexanediol dimethacrylate, 1,6-hexanediol (EO)n diacrylate, polypropylene glycol 400 diacrylate, 1,4-butanediol dimethacrylate, polypropylene glycol 700 (EO)6 dimethacrylate, 1,6-Hexanediol (EO)n diacrylate, hydroxy pivalic acid neopentyl glycol diacrylate, bisphenol A (EO)10 diacrylate, bisphenol A (EO)10 dimethacrylate, neopentyl glycol dimethacrylate, neopentyl glycol (PO)2 diacrylate, tripropylene glycol diacrylate, ethylene glycol dimethacrylate, dipropylene glycol diacrylate, bisphenol A (EO)30 diacrylate, bisphenol A (EO)30 dimethacrylate, diethylene glycol dimethacrylate, triethylene glycol diacrylate, triethylene glycol dimethacrylate, tetraethylene glycol dimethacrylate, bisphenol A (EO)4 diacrylate, bisphenol A (EO)4 dimethacrylate, bisphenol A (EO)3 diacrylate, bisphenol A (EO)3 dimethacrylate, 1,3-butylene glycol dimethacrylate, tricyclodecane dimethanol diacrylate, tetraethylene glycol diacrylate, polyethylene glycol 400 diacrylate, polyethylene glycol 400 dimethacrylate, polyethylene glycol 200 diacrylate, polyethylene glycol 200 dimethacrylate, polyethylene glycol 300 diacrylate, polyethylene glycol 600 diacrylate, polyethylene glycol 600 dimethacrylate, bisphenol F (EO)4 diacrylate, trimethylolpropane triacrylate, trimethylolpropane trimethacrylate, trimethylolpropane (EO)3 triacrylate, trimethylolpropane (EO)15 triacrylate, trimethylolpropane (EO)6 triacrylate, trimethylolpropane (EO)9 triacrylate, glycerine (PO)3 triacrylate, pentaerythritol triacrylate, trimethylolpropane (PO)3 triacrylate, tris(2-hydroxyethyl)isocyanurate triacrylate, pentaerythritol (EO)n tetraacrylate, ditrimethylolpropane tetraacrylate, pentaerythritol tetraacrylate, dipentaerythritol pentaacrylate, and dipentaerythritol hexaacrylate.

In some embodiments, the base resin component includes one or more of a phosphate methacrylate, an amine acrylate, an acrylated amine synergist, a carboxylethyl acrylate, a modified epoxy acrylate, a bisfluorene diacrylate, a modified bisphenol fluorene diacrylate, a modified bisphenol fluorene type, a butadiene acrylate, an aromatic difunctional acrylate, an aliphatic multifunctional acrylate, a polyester acrylate, a trifunctional polyester acrylate, a tetrafunctional polyester acrylate, a phenyl epoxy acrylate, a bisphenol A epoxy acrylate, a water soluble acrylate, an aliphatic alkyl epoxy acrylate, a bisphenol A epoxy methacrylate, a soybean oil epoxy acrylate, a difunctional polyester acrylate, a trifunctional polyester acrylate, a tetrafunctional polyester acrylate, a chlorinated polyester acrylate, a hexafunctional polyester acrylate, an aliphatic difunctional acrylate, an aliphatic difunctional methacrylate, an aliphatic trifunctional acrylate, an aliphatic trifunctional methacrylate, an aromatic difunctional acrylate, an aromatic tetrafunctional acrylate, an aliphatic tetrafunctional acrylate, an aliphatic hexafunctional acrylate, an aromatic hexafunctional acrylate, an acrylic acrylate, a polyester acrylate, a sucrose benzoate, a caprolactone methacrylate, a caprolactone acrylate, a phosphate methacrylate, an aliphatic multifunctional acrylate, a phenol novolac epoxy acrylate, a cresol novolac epoxy acrylate, an alkali strippable polyester acrylate, a melamine acrylate, a silicone polyester acrylate, a silicone urethane acrylate, a dendritic acrylate, an aliphatic tetrafunctional methacrylate, a water dispersion urethane acrylate, a water soluble acrylate, an aminated polyester acrylate, a modified epoxy acrylate, or a trifunctional polyester acrylate.

In some embodiments, the base resin component includes one or more of:

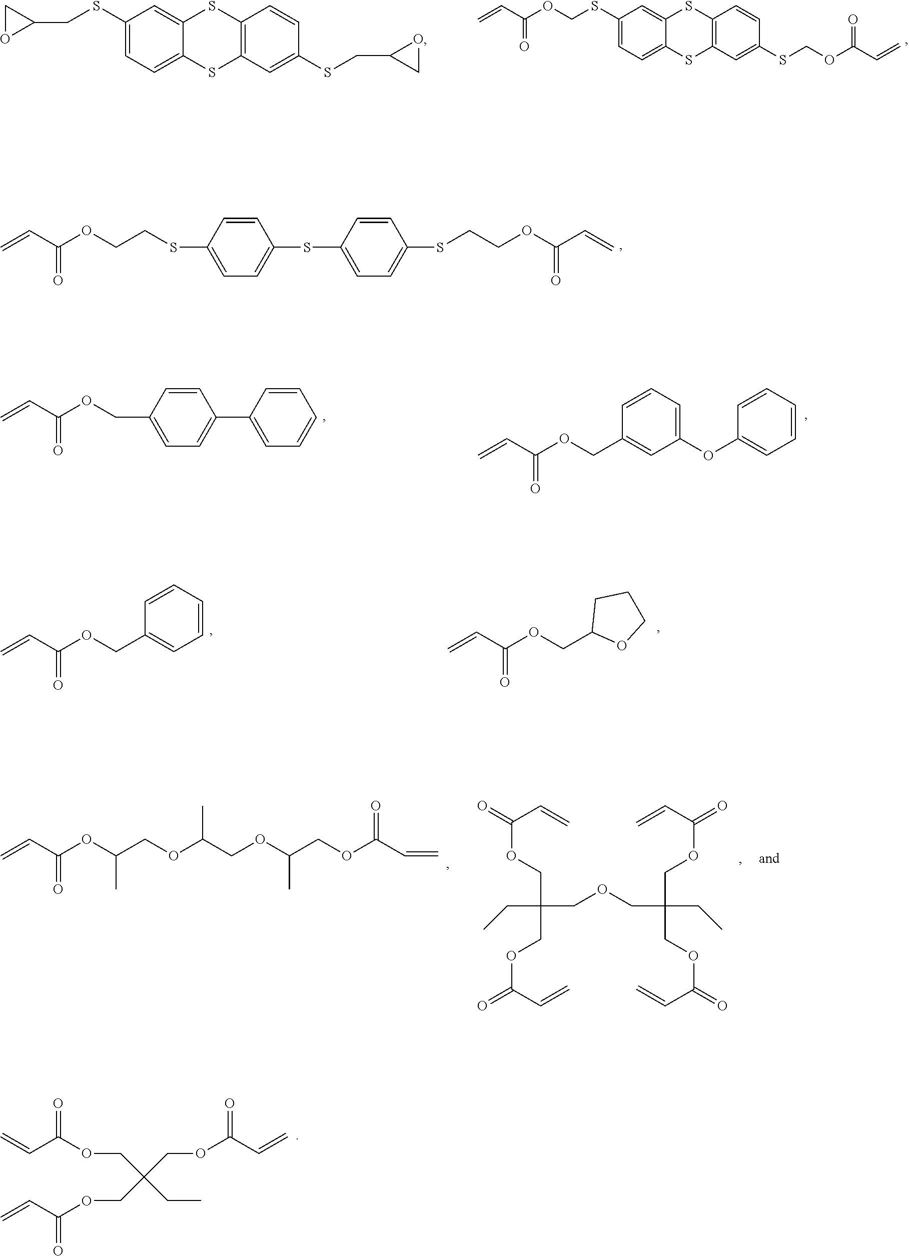

In some embodiments, the base resin component includes one or more of:

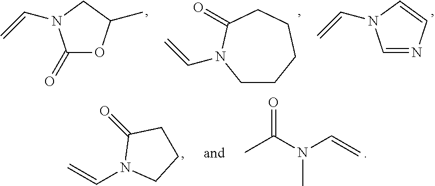

In some embodiments, the base resin component includes one or more fluorinated compounds. In some embodiments, the one or more fluorinated compounds are selected from: 2,2,3,3,4,4,5,5,6,6,7,7-dodecafluoroheptyl acrylate, 3,3,4,4,5,5,6,6,7,7,8,8,9,9,10,10,11,11,12,12,12-heneicosafluorododecyl acrylate, 3,3,4,4,5,5,6,6,7,7,8,8,9,9,10,10,10-heptadecafluorodecyl methacrylate, 2,2,3,3,4,4,4-heptafluorobutyl acrylate, 2,2,3,3,4,4,4-heptafluorobutyl methacrylate, 2,2,3,4,4,4-hexafluorobutyl acrylate, 2,2,3,4,4,4-hexafluorobutyl methacrylate, 1,1,1,3,3,3-hexafluoroisopropyl acrylate, 1,1,1,3,3,3-hexafluoroisopropyl methacrylate, 2,2,3,3,4,4,5,5-octafluoropentyl acrylate, 2,2,3,3,4,4,5,5-octafluoropentyl methacrylate, 2,2,3,3,3-pentafluoropropyl acrylate, 2,2,3,3,3-pentafluoropropyl methacrylate, 1H,1H,2H,2H-perfluorodecyl acrylate, 2,2,3,3-tetrafluoropropyl methacrylate, 3,3,4,4,5,5,6,6,7,7,8,8,8-tridecafluorooctyl acrylate, 3,3,4,4,5,5,6,6,7,7,8,8,8-tridecafluorooctyl methacrylate, 2,2,2-trifluoroethyl methacrylate, and 2-[(1′,1′,1′-trifluoro-2′-(trifluoromethyl)-2′-hydroxy)propyl]-3-norbornyl methacrylate.

In some embodiments, the base resin component further includes one or more solvents. In some embodiments, the one or more solvents are selected from 2-(1-methoxy)propyl acetate, propylene glycol monomethyl ether acetate, propylene glycol methyl ether, ethyl acetate, xylene, and toluene.

In some embodiments, the one or more additives include small molecules or polymers with molecular weight ranging from 500 g/mol to 1,000,000 kg/mol with one or more aromatic groups with hydroxyl or acid, alkyl ether, or alkyl ester functional groups that connect to the aromatic groups. In some embodiments, the one or more additives are selected from poly(4-vinylphenol), poly(acetoxystyrene), poly(methoxystyrene), poly(di-acetoxystyrene), poly(di-methoxystyrene), cresol novolac, catechol novolac, phthalic acid, 3-methylcatechol, caffeic acid, eugenol, or vinyl-phosphonic acid.

In some embodiments, a percentage of a solid material in the formulation ranges from 0.1% to 60%, from 1% to 10% or from 3%-10%.

### Examples and Experimental Data

In some embodiments, a method of preparing a formulation includes adding all formulation components into a bottle, mixing (e.g., using vortex mixer for 1 minute) and filtering (e.g., through 0.2 micrometer polytetrafluoroethylene (PTFE) filter).

In some embodiments, a method of coating a film of the formulation includes spin coating or inkjet printing the formulation onto a substrate (e.g., silicon substrate). In some embodiments, the method includes heating the film (e.g., at 110° Celsius for 1 minute), UV curing the film (e.g., using a broad band LED lamp with dose of 6 J/cm2 (measured at 365 nm)), and/or subsequently heating the film (e.g., at 135° Celsius or 150° Celsius for 5 min for baking).

In some embodiments, the method includes spin coating or inkjet printing a formulation onto a substrate (e.g., a Si substrate), heating the film (e.g., at 110° Celsius for 1 min), and heating the film for the second time at a higher temperature (e.g., at 150° Celsius or 200 nm for 1-5 min). In some embodiments, the method includes spin coating or inkjet printing the formulation (e.g., the formulation including propylene glycol methyl ether acetate (PGMEA) and di(propylene glycol) methyl ether (DPGME)) onto a substrate (e.g., a silicon substrate), heating the film (e.g., at 110° Celsius for 1 min), and subsequently heating the film at a higher temperature (e.g., at 300-600° Celsius for 20-60 min for baking).

The refractive index of the formed film may be measured using an ellipsometer (e.g., using a Cauchy model on a Si substrate).

In some cases, a puddle of PGMEA was dispensed on a cured film, developed for 60 seconds, and spun off at 2000 rpm for 60 seconds. Residual PGMEA was removed at 110° Celsius for 60 seconds. The refractive index and the film thickness after PGMEA stripping were measured and compared to the refractive index and the film thickness before PGMEA stripping.

In some embodiments, a film made of the formulation described herein has a lower than 1% optical loss at 460 nm.

The following example formulations and comparative examples were prepared and tested.

| | Composition | Amount |
|---|---|---|
| Example 1 | CG-500 | 1.90% |
| | CPI-310B | 0.06% |
| | DPGMEA | 45% |
| | PGMEA | 37% |
| | Titanium oxide blend (50 wt. % Titanium | 16% |
| | oxide nanoparticles in PGMEA) S83J epoxy | |
| Example 2 | CG-500 | 0.97% |
| | CPI-310B | 0.03% |
| | DPGMEA | 45% |
| | PGMEA | 36% |
| | Titanium oxide blend (50 wt. % Titanium | 18% |
| | oxide nanoparticles in PGMEA) S105B epoxy | |
| Example 3 | CG-500 | 0.94% |
| | CPI-310B | 0.03% |
| | Omnirad 481 | 0.03% |
| | DPGMEA | 45% |
| | PGMEA | 36% |
| | Titanium oxide blend (50 wt. % Titanium | 18% |
| | oxide nanoparticles in PGMEA) LT28B acrylate | |
| Example 4 | CG-500 | 0.97% |
| | TAG-2678 | 0.03% |
| | DPGMEA | 45% |
| | PGMEA | 36% |
| | Titanium oxide blend (50 wt. % Titanium | 18% |
| | oxide nanoparticles in PGMEA) LT28B | |
| Example 5 | CG-500 | 0.97% |
| | TAG-2678 | 0.03% |
| | DPGMEA | 81% |
| | Titanium oxide blend (50 wt. % Titanium | 18% |
| | oxide nanoparticles in PGMEA) LT28B | |
| Example 6 | EG-200 | 0.78% |
| | CG-500 | 0.97% |
| | CN-153 | 0.19% |
| | TAG-2678 | 0.06% |
| | PGMEA | 62% |
| | Titanium oxide blend (50 wt. % Titanium | 36% |
| | oxide nanoparticles in PGMEA) LT28B | |
| Example 7 | CG-500 | 0.49% |
| | PHS | 0.49% |
| | CPI-310B | 0.01% |
| | Omnirad 481 | 0.01% |
| | TPM | 81% |
| | Titanium oxide blend (50 wt. % Titanium | 36% |
| | oxide nanoparticles in PGMEA) LT28B | |
| Example 8 | LPB-1102 | 2.90% |
| | SB-8 | 0.50% |
| | AD-50 | 0.30% |
| | PGMEA | 24.20% |
| | Titanium oxide blend (50 wt. % Titanium | 73.20% |
| | oxide nanoparticles in PGMEA) LT-28B | |
| Example 9 | Miramer 1192 | 0.59% |
| | TMP3A | 0.29% |
| | NVP | 0.09% |
| | Diphenyl(2,4,6 trimethylbenzoyl)phosphine oxide | 0.03% |
| | 2-Hydroxy-2-methylpropiophenone 50/50 blend | |
| | Titanium oxide blend (50 wt. % Titanium | 18.00% |
| | oxide nanoparticles in PGMEA) LT-31B | |
| | DPGMEA | 36.00% |
| | PGMEA | 45.00% |
| Example 10 | Miramer 1192 | 1.70% |
| | TMP3A | 0.73% |
| | Diphenyl(2,4,6 trimethylbenzoyl)phosphine oxide | 0.08% |
| | 2-Hydroxy-2-methylpropiophenone 50/50 blend | |
| | Titanium oxide blend (50 wt. % Titanium | 15.00% |
| | oxide nanoparticles in PGMEA) LT-31B acrylate | |
| | DPGMEA | 45.00% |
| | PGMEA | 37.50% |
| Example 11 | OG SOL GA-5060p | 0.97% |
| | Diphenyl(2,4,6 trimethylbenzoyl)phosphine oxide | 0.015% |
| | 2-Hydroxy-2-methylpropiophenone 50/50 blend | |
| | CPI-310B | 0.015% |
| | Titanium oxide blend (50 wt. % Titanium | 18.00% |
| | oxide nanoparticles in PGMEA) LT-31B | |
| | DPGMEA | 45.00% |
| | PGMEA | 36.00% |
| Example 12 | MHM-06 TiOx metal complexes solution | 25.00% |
| | DPGME | 50.00% |
| | PGMEA | 25.00% |
| Comparative | CG-500 | 0.98% |
| Example 1 | CPI-310B | 0.01% |
| | Omnirad 481 | 0.01% |
| | TPM | 81% |
| | Titanium oxide blend (50 wt. % Titanium | 36% |
| | oxide nanoparticles in PGMEA) LT28B | |
| Comparative | CG-500 | 0.98% |
| Example 2 | CPI-310B | 0.01% |
| | Omnirad 481 | 0.01% |
| | 3-phenoxy toluene | 81% |
| | Titanium oxide blend (50 wt. % Titanium | 36% |
| | oxide nanoparticles in PGMEA) LT28B | |
| Comparative | CG-500 | 9.70% |
| Example 3 | CPI-310B | 0.30% |
| | PGMEA | 90% |
| Comparative | CG-500 | 0.94% |
| Example 4 | CPI-310B | 0.03% |
| | Omnirad 481 | 0.03% |
| | Anisole | 54% |
| | 3-phenoxy toluene | 27% |
| | Titanium oxide blend (50 wt. % Titanium | 18% |
| | oxide nanoparticles in PGMEA) LT28B acrylate | |
| Comparative | CG-500 | 0.94% |
| Example 5 | CPI-310B | 0.03% |
| | Omnirad 481 | 0.03% |
| | PGMEA | 36% |
| | butyl lactate | 45% |
| | Titanium oxide blend (50 wt. % Titanium | 18% |
| | oxide nanoparticles in PGMEA) LT28B acrylate | |

CG-500 was obtained from Osaka Chemical, CPI-310B was obtained from San-Pro, DPGMEA was obtained from Sigma, PGMEA was obtained from Sigma, titanium oxide blend was obtained from Pixelligent, Omnirad 481 was obtained from IGM Resins, TAG-2678 was obtained from King Industries, Inc., PHS was obtained from Sigma, LPB-1102, SB-8, and AD-50 were obtained from Mitsubishi Gas Chemical, Miramer 1192 was obtained from Miwon, TMP3A was obtained from Osaka Organic Chemical, Diphenyl(2,4,6 trimethylbenzoyl)phosphine oxide-2-Hydroxy-2-methylpropiophenone blend was obtained from Sigma Aldrich, OG SOL GA-5060p was obtained from Osaka Chemical, MHM-06 TiOx metal complexes solution was obtained from Merck.

The properties of these formulations were as follows:

| | | | | RI loss | Thickness | |
|---|---|---|---|---|---|---|
| | Surface wetting | Nozzle | RI | after | loss after | Optical |
| Sample | on TiOx and Si | Clogging | @520 nm | PGMEA strip | PGMEA strip | loss % |
| Example 1 | A | A | 2.05 | <0.01 | <3 nm | |
| Example 2 | A | A | 2.06 | <0.01 | <3 nm | 0.4 |
| Example 3 | A | A | 2.05 | <0.01 | <3 nm | 0.32 |
| Example 4 | A | A | 2.04 | <0.01 | <3 nm | 0.44 |
| Example 5 | B | A | 2.04 | <0.01 | <3 nm | 0.44 |
| Example 6 | A | A | 2.025 | <0.01 | <3 nm | 0.43 |
| Example 7 | A | A | 2.02 | <0.01 | <3 nm | <1 |
| Example 8 | | | 1.993 @589 | <0.01 | <3 nm | |
| Example 9 | A | A | 1.99 | <0.01 | <3 nm | 0.2 |
| Example 10 | A | A | 1.99 | <0.01 | <3 nm | 0.2 |
| Example 11 | | | 2.04 | <0.01 | <3 nm | 0.78 |
| Example 12 | A | A | 2.05 | <0.01 | <3 nm | 0.45-0.1 |
| Comparative | B | B | 2.05 | <0.01 | <3 nm | |
| Example 1 | | | | | | |
| Comparative | C | B | 2.04 | <0.01 | <3 nm | |
| Example 2 | | | | | | |
| Comparative | | | 1.71 | | | 0.21 |
| Example 3 | | | | | | |
| Comparative | C | B | 2.05 | <0.01 | <3 nm | 0.32 |
| Example 4 | | | | | | |
| Comparative | NA | C | 2.05 | <0.01 | <3 nm | 0.32 |
| Example 5 | | | | | | |

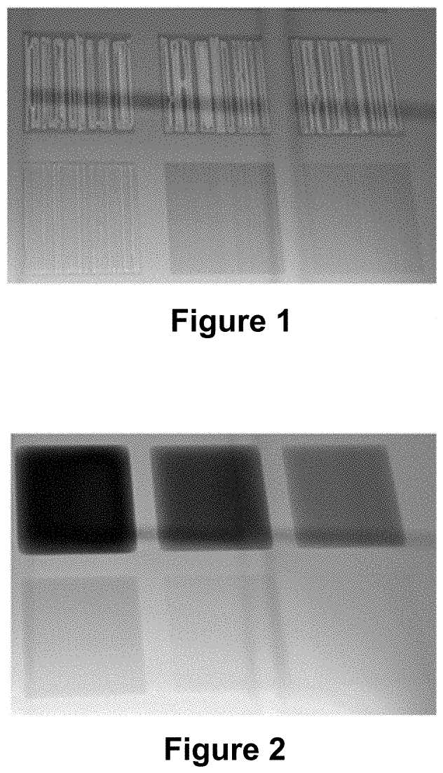

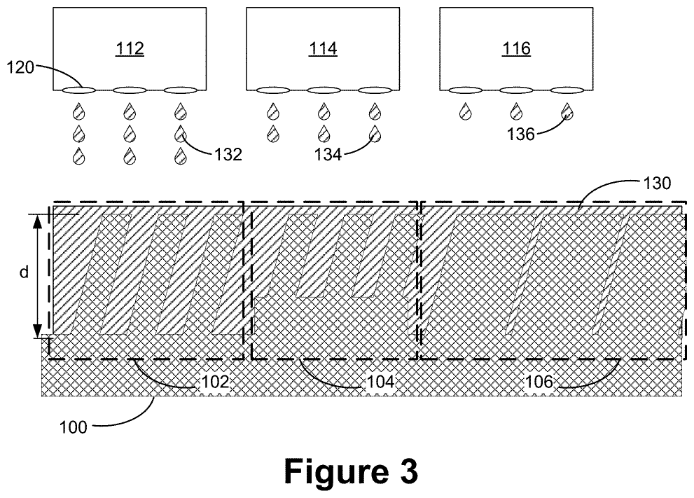

The surface wetting was determined by measuring the smoothness of a film formed by the inkjet printing. A: both 6 pL and 48 pL with 360 dpi-by-360 dpi print show continuous smooth film, B: 6 pL show non-continuous film but 48 pL show continuous film, C: Neither 6 pL or 48 pL show continuous film. NA: can't be tested due to clogging. FIGS. 1 and 2 are photographs of TiO₂ substrates coated with some of the above-listed formulations in accordance with some embodiments. FIG. 2 shows TiO₂ substrates on which comparative example formulations formed non-uniform coatings, whereas FIG. 3 shows TiO2 substrates on which example formulations formed uniform coatings.

Nozzle clogging: A: no clogging with dummy dispense with 10 min dwelling time, B: partial clogging, need wiping to recover nozzle after 10 min, C: clog immediately, no jetting.

### Inkjet Printing

In some embodiments, a method of inkjet printing a formulation is performed with an inkjet printer or an equivalent device (e.g., having a nozzle 120 and an actuator, such as a piezo actuator, in a print head 112 shown in FIG. 3 to eject one or more droplets of the formulation through the nozzle 120). In some embodiments, the method includes flushing an ink chamber and the print head 112 of the inkjet printer or an equivalent device with a solvent, such as PGMEA. The method includes loading the formulation into the ink chamber of the inkjet printer (e.g., through a 0.1 μm˜0.2 μm filter). In some embodiments, the method includes purging the formulation through the print head. In some embodiments, the method includes dispensing the material to prime the nozzles. The formulation is ejected through the nozzle 120 by applying a waveform having preselected peak-to-peak voltages and a preselected firing frequency when the print head has a preselected head temperature to achieve stable jetting. The jetting velocity may be selected to be at least 3 m/s.

In some embodiments, the amount of the formulation dispensed on a respective region of a substrate is controlled based on a surface profile of the substrate (e.g., for a non-flat surface) so that a layer 130 of the formulation having a uniform overburden is obtained. In some embodiments, the overburden has a flat top surface (e.g., the layer 130 has a flat top surface). For example, the amount of the formulation dispensed on a respective region of a substrate is selected based on the height and the duty cycle of grating features (e.g., grating grooves) of a surface-relief grating. In FIG. 3, the substrate 100 includes a first portion 102, a second portion 104, and a third portion 106, which includes different surface structures (e.g., grooves of a surface-relief grating). For example, in FIG. 3, the first portion 102 includes grooves of a low duty cycle and a high depth d (e.g., a distance from the top surface of the groove to the bottom surface of the groove in a direction perpendicular to a plane defined by the substrate), while the second portion 104 includes grooves of a low duty cycle and a low depth, and the third portion 106 includes grooves of a high duty cycle and a high depth. In some embodiments, a first amount 132 of the formulation (e.g., a volume of the formulation per unit substrate area) is deposited on a first portion 102 of a substrate 100 having a non-flat surface (e.g., a first portion of a surface relief grating) and a second amount 134, distinct from the first amount 132, of the formulation is deposited on a second portion 104 of the substrate 100 having the non-flat surface. In some embodiments, the first portion 102 and the second portion 104 are distinct and mutually exclusive to each other. In some embodiments, as shown in FIG. 3, a third amount 136, distinct from the first amount 132 or the second amount 134, of the formulation is deposited on a third portion 106 of the substrate 100 having the non-flat surface. In some embodiments, the first portion 102, the second portion 104, and the third portion 106 are distinct and mutually exclusive to one another. In some embodiments, the first amount 132 is greater than the second amount 134, and the second amount 134 is greater than the third amount 136. In some embodiments, such deposition forms a layer 130 of the formulation having a flat overburden (e.g., a flat top surface). Although FIG. 3 illustrates the first portion 102, the second portion 104, and the third portion 106 to be positioned adjacent to one another, in some embodiments, the first portion 102, the second portion 104, and the third portion 106 may be separated from one another by a predefined distance (e.g., at least 1 mm, 2 mm, 3 mm, 4 mm, 5 mm, 6 mm, 7 mm, 8 mm, 9 mm, 10 mm, etc.).

FIG. 3 also illustrates printer heads 112, 114, and 116. In some embodiments, the printer heads 112, 114, and 116 are a same printer head located at three different positions. For example, the same printer head may be moved sequentially to different positions for depositing the formulation (e.g., after the same printer head is located at a position corresponding to the printer head 112 for depositing the first amount of the formulation on the first portion 102 of the substrate, the printer head is moved to a position corresponding to the printer head 114 for depositing the second amount of the formulation on the second portion 104 of the substrate, and then the printer head is moved to a position corresponding to the printer head 116 for depositing the third amount of the formulation on the third portion 106 of the substrate). In some embodiments, the printer heads 112, 114, and 116 are distinct and separate printer heads. In some embodiments, at least two printer heads of the printer heads 112, 114, and 116 concurrently deposit the formulations.

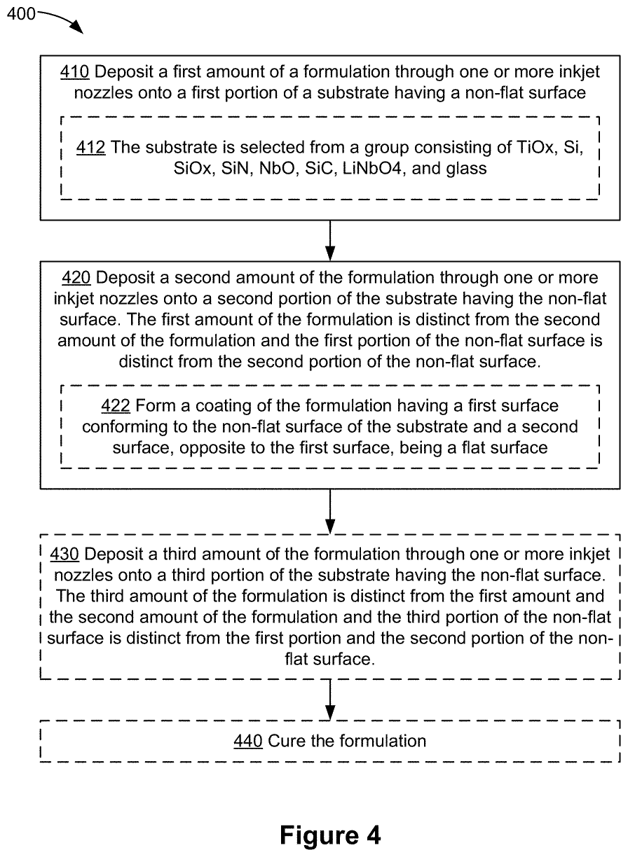

FIG. 4 is a flow diagram illustrating a method 400 of depositing a formulation using an inkjet nozzle in accordance with some embodiments.

The method 400 includes (410) depositing a first amount of any formulation described herein through one or more inkjet nozzles onto a first portion of a substrate having a non-flat surface.

In some embodiments, the substrate is selected (412) from a group consisting of TiOx, Si, SiOx, SiN, NbO, SiC, LiNbO3, and glass.

The method 400 also includes (420) depositing a second amount of the formulation through one or more inkjet nozzles onto a second portion of the substrate having the non-flat surface. The first amount of the formulation is distinct from the second amount of the formulation and the first portion of the non-flat surface is distinct from the second portion of the non-flat surface. In some embodiments, the one or more inkjet nozzles used for depositing the second amount of the formulation are the same as the one or more inkjet nozzles used for depositing the first amount of the formulation (e.g., the one or more inkjet nozzles used for depositing the first amount of the formulation on the first portion of the substrate are moved over the second portion of the substrate to deposit the second amount of the formulation on the second portion of the substrate). In some embodiments, the one or more inkjet nozzles used for depositing the second amount of the formulation are distinct from the one or more inkjet nozzles used for depositing the first amount of the formulation (e.g., the one or more inkjet nozzles used for depositing the first amount of the formulation and the one or more inkjet nozzles used for depositing the second amount of the formulation are used to concurrently deposit the first amount of the formulation on the first portion of the substrate and the second amount of the formulation on the second portion of the substrate).

In some embodiments, depositing the first amount of the formulation and the second amount of the formulation (422) forms a coating of the formulation having a first surface (e.g., a bottom surface) conforming to the non-flat surface of the substrate and a second surface (e.g., a top surface) opposite to the first surface, where the second surface is a flat surface.

In some embodiments, the method 400 also includes (430) depositing a third amount of the formulation through one or more inkjet nozzles onto a third portion of the substrate having the non-flat surface. The third amount of the formulation is distinct from the first amount and the second amount of the formulation and the third portion of the non-flat surface is distinct from the first portion and the second portion of the non-flat surface. In some embodiments, the one or more inkjet nozzles used for depositing the third amount of the formulation are the same as the one or more inkjet nozzles used for depositing the second amount of the formulation (e.g., the one or more inkjet nozzles used for depositing the second amount of the formulation on the second portion of the substrate are moved over the third portion of the substrate to deposit the third amount of the formulation on the third portion of the substrate). In some embodiments, the one or more inkjet nozzles used for depositing the third amount of the formulation are distinct from the one or more inkjet nozzles used for depositing the second amount of the formulation (e.g., the one or more inkjet nozzles used for depositing the second amount of the formulation and the one or more inkjet nozzles used for depositing the third amount of the formulation are used to concurrently deposit the second amount of the formulation on the second portion of the substrate and the third amount of the formulation on the third portion of the substrate). In some embodiments, the one or more inkjet nozzles used for depositing the first amount of the formulation, the one or more inkjet nozzles used for depositing the second amount of the formulation, and the one or more inkjet nozzles used for depositing the third amount of the formulation are used to concurrently deposit the first amount of the formulation on the first portion of the substrate, the second amount of the formulation on the second portion of the substrate, and the third amount of the formulation on the third portion of the substrate.

In some embodiments, the method 400 further includes (440) curing the formulation. In some embodiments, curing the formulation includes thermally curing the formulation (e.g., by changing a temperature of the formulation to a particular temperature). In some embodiments, curing the formulation includes curing the formulation with ultraviolet light (e.g., by exposing the formulation to ultraviolet light). In some embodiments, the method 400 includes curing at least the base resin in the formulation.

### Optical Devices

In some embodiments, an optical device includes a surface relief grating and a coating layer disposed on the surface relief grating (e.g., as shown in FIG. 3). The coating layer includes the formulation described herein. In some embodiments, the formulation includes a plurality of nanoparticles having a refractive index greater than 1.45 and a resin having a refractive index ranging from 1.45 to 1.8, from 1.6 to 1.8, or from 1.7 to 1.8. The plurality of nanoparticles has functional ligands cross-linked with the resin.

In some embodiments, the optical device includes a waveguide optically coupled with the surface relief grating. The surface relief grating may operate as an input coupler or an output coupler. In some implementations, the waveguide is included in a head-mounted display device.

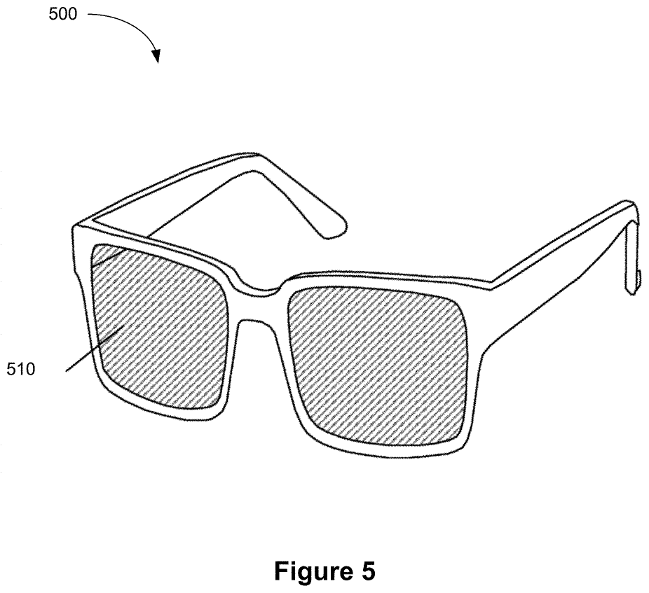

FIG. 5 illustrates display device 500 in accordance with some embodiments. In some embodiments, display device 500 is configured to be worn on a head of a user (e.g., by having the form of spectacles or eyeglasses, as shown in FIG. 5) or to be included as part of a helmet that is to be worn by the user. When display device 500 is configured to be worn on a head of a user or to be included as part of a helmet, display device 500 is called a head-mounted display. Alternatively, display device 500 is configured for placement in proximity of an eye or eyes of the user at a fixed location, without being head-mounted (e.g., display device 500 is mounted in a vehicle, such as a car or an airplane, for placement in front of an eye or eyes of the user). As shown in FIG. 5, display device 500 includes display 510. Display 510 is configured for presenting visual contents (e.g., augmented reality contents, virtual reality contents, mixed reality contents, or any combination thereof) to a user.

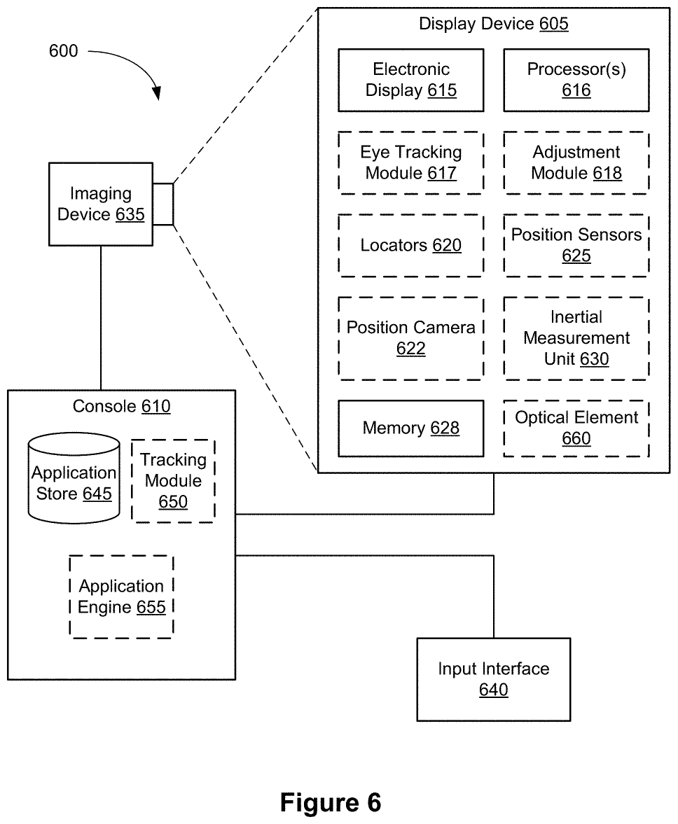

In some embodiments, display device 500 includes one or more components described herein with respect to FIG. 6. In some embodiments, display device 500 includes additional components not shown in FIG. 6.

FIG. 6 is a block diagram of system 600 in accordance with some embodiments. The system 600 shown in FIG. 6 includes display device 605 (which corresponds to display device 500 shown in FIG. 5), imaging device 635, and input interface 640 that are each coupled to console 610. While FIG. 6 shows an example of system 600 including one display device 605, imaging device 635, and input interface 640, in other embodiments, any number of these components may be included in system 600. For example, there may be multiple display devices 605 each having associated input interface 640 and being monitored by one or more imaging devices 635, with each display device 605, input interface 640, and imaging devices 635 communicating with console 610. In alternative configurations, different and/or additional components may be included in system 600. For example, in some embodiments, console 610 is connected via a network (e.g., the Internet or a wireless network) to system 600 or is self-contained as part of display device 605 (e.g., physically located inside display device 605). In some embodiments, display device 605 is used to create mixed reality by adding in a view of the real surroundings. Thus, display device 605 and system 600 described here can deliver augmented reality, virtual reality, and mixed reality.

In some embodiments, as shown in FIG. 5, display device 605 is a head-mounted display that presents media to a user. Examples of media presented by display device 605 include one or more images, video, audio, or some combination thereof. In some embodiments, audio is presented via an external device (e.g., speakers and/or headphones) that receives audio information from display device 605, console 610, or both, and presents audio data based on the audio information. In some embodiments, display device 605 immerses a user in an augmented environment.

In some embodiments, display device 605 also acts as an augmented reality (AR) headset. In these embodiments, display device 605 augments views of a physical, real-world environment with computer-generated elements (e.g., images, video, sound, etc.). Moreover, in some embodiments, display device 605 is able to cycle between different types of operation. Thus, display device 605 operate as a virtual reality (VR) device, an augmented reality (AR) device, as glasses or some combination thereof (e.g., glasses with no optical correction, glasses optically corrected for the user, sunglasses, or some combination thereof) based on instructions from application engine 655.

Display device 605 includes electronic display 615, one or more processors 616, eye tracking module 617, adjustment module 618, one or more locators 620, one or more position sensors 625, one or more position cameras 622, memory 628, inertial measurement unit (IMU) 630, one or more optical elements 660 or a subset or superset thereof (e.g., display device 605 with electronic display 615, one or more processors 616, and memory 628, without any other listed components). Some embodiments of display device 605 have different modules than those described here. Similarly, the functions can be distributed among the modules in a different manner than is described here.

One or more processors 616 (e.g., processing units or cores) execute instructions stored in memory 628. Memory 628 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 628, or alternately the non-volatile memory device(s) within memory 628, includes a non-transitory computer readable storage medium. In some embodiments, memory 628 or the computer readable storage medium of memory 628 stores programs, modules and data structures, and/or instructions for displaying one or more images on electronic display 615.

Electronic display 615 displays images to the user in accordance with data received from console 610 and/or processor(s) 616. In various embodiments, electronic display 615 may comprise a single adjustable display element or multiple adjustable display elements (e.g., a display for each eye of a user). In some embodiments, electronic display 615 is configured to display images to the user by projecting the images onto one or more optical elements 660.

In some embodiments, the display element includes one or more light emission devices and a corresponding array of spatial light modulators. A spatial light modulator is an array of electro-optic pixels, opto-electronic pixels, some other array of devices that dynamically adjust the amount of light transmitted by each device, or some combination thereof. These pixels are placed behind one or more lenses. In some embodiments, the spatial light modulator is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The spatial light modulator is configured to selectively attenuate individual light emission devices, groups of light emission devices, or some combination thereof Alternatively, when the light emission devices are configured to selectively attenuate individual emission devices and/or groups of light emission devices, the display element includes an array of such light emission devices without a separate emission intensity array. In some embodiments, electronic display 615 projects images to one or more optical elements 660, which reflect at least a portion of the light toward an eye of a user.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 605 (e.g., a user wearing display device 605) for viewing images from display device 605. In some cases, the eyebox is represented as a 10 mm×10 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed. As used herein, IR refers to light with wavelengths ranging from 700 nm to 1 mm including near infrared (NIR) ranging from 750 nm to 1500 nm.

Eye tracking module 617 determines locations of each pupil of a user's eyes. In some embodiments, eye tracking module 617 instructs electronic display 615 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 617 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 617 maps the locations of the user's pupil while looking at the reference points to corresponding signals received on the IR tracking array). As mentioned above, in some embodiments, system 600 may use other eye tracking systems than the embedded IR one described herein.

Adjustment module 618 generates an image frame based on the determined locations of the pupils. In some embodiments, this sends a discrete image to the display that will tile subimages together thus a coherent stitched image will appear on the back of the retina. Adjustment module 618 adjusts an output (i.e. the generated image frame) of electronic display 615 based on the detected locations of the pupils. Adjustment module 618 instructs portions of electronic display 615 to pass image light to the determined locations of the pupils. In some embodiments, adjustment module 618 also instructs the electronic display to not pass image light to positions other than the determined locations of the pupils. Adjustment module 618 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 620 are objects located in specific positions on display device 605 relative to one another and relative to a specific reference point on display device 605. A locator 620 may be a light emitting diode (LED), a corner cube reflector, a reflective marker, a type of light source that contrasts with an environment in which display device 605 operates, or some combination thereof. In embodiments where locators 620 are active (e.g., an LED or other type of light emitting device), locators 620 may emit light in the visible band (e.g., about 500 nm to 750 nm), in the infrared band (e.g., about 750 nm to 1 mm), in the ultraviolet band (about 100 nm to 500 nm), some other portion of the electromagnetic spectrum, or some combination thereof.

In some embodiments, locators 620 are located beneath an outer surface of display device 605, which is transparent to the wavelengths of light emitted or reflected by locators 620 or is thin enough to not substantially attenuate the wavelengths of light emitted or reflected by locators 620. Additionally, in some embodiments, the outer surface or other portions of display device 605 are opaque in the visible band of wavelengths of light. Thus, locators 620 may emit light in the IR band under an outer surface that is transparent in the IR band but opaque in the visible band.

IMU 630 is an electronic device that generates calibration data based on measurement signals received from one or more position sensors 625. Position sensor 625 generates one or more measurement signals in response to motion of display device 605. Examples of position sensors 625 include: one or more accelerometers, one or more gyroscopes, one or more magnetometers, another suitable type of sensor that detects motion, a type of sensor used for error correction of IMU 630, or some combination thereof. Position sensors 625 may be located external to IMU 630, internal to IMU 630, or some combination thereof.

Based on the one or more measurement signals from one or more position sensors 625, IMU 630 generates first calibration data indicating an estimated position of display device 605 relative to an initial position of display device 605. For example, position sensors 625 include multiple accelerometers to measure translational motion (forward/back, up/down, left/right) and multiple gyroscopes to measure rotational motion (e.g., pitch, yaw, roll). In some embodiments, IMU 630 rapidly samples the measurement signals and calculates the estimated position of display device 605 from the sampled data. For example, IMU 630 integrates the measurement signals received from the accelerometers over time to estimate a velocity vector and integrates the velocity vector over time to determine an estimated position of a reference point on display device 605. Alternatively, IMU 630 provides the sampled measurement signals to console 610, which determines the first calibration data. The reference point is a point that may be used to describe the position of display device 605. While the reference point may generally be defined as a point in space; however, in practice the reference point is defined as a point within display device 605 (e.g., a center of IMU 630).

In some embodiments, IMU 630 receives one or more calibration parameters from console 610. As further discussed below, the one or more calibration parameters are used to maintain tracking of display device 605. Based on a received calibration parameter, IMU 630 may adjust one or more IMU parameters (e.g., sample rate). In some embodiments, certain calibration parameters cause IMU 630 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 635 generates calibration data in accordance with calibration parameters received from console 610. Calibration data includes one or more images showing observed positions of locators 620 that are detectable by imaging device 635. In some embodiments, imaging device 635 includes one or more still cameras, one or more video cameras, any other device capable of capturing images including one or more locators 620, or some combination thereof. Additionally, imaging device 635 may include one or more filters (e.g., used to increase signal to noise ratio). Imaging device 635 is configured to optionally detect light emitted or reflected from locators 620 in a field of view of imaging device 635. In embodiments where locators 620 include passive elements (e.g., a retroreflector), imaging device 635 may include a light source that illuminates some or all of locators 620, which retro-reflect the light towards the light source in imaging device 635. Second calibration data is communicated from imaging device 635 to console 610, and imaging device 635 receives one or more calibration parameters from console 610 to adjust one or more imaging parameters (e.g., focal length, focus, frame rate, ISO, sensor temperature, shutter speed, aperture, etc.).

In some embodiments, display device 605 optionally includes one or more optical elements 660 (e.g., lenses, reflectors, gratings, etc.). In some embodiments, electronic display device 605 includes a single optical element 660 or multiple optical elements 660 (e.g., an optical element 660 for each eye of a user). In some embodiments, electronic display 615 projects computer-generated images on one or more optical elements 660, such as a reflective element, which, in turn, reflect the images toward an eye or eyes of a user. The computer-generated images include still images, animated images, and/or a combination thereof. The computer-generated images include objects that appear to be two-dimensional and/or three-dimensional objects. In some embodiments, one or more optical elements 660 are partially transparent (e.g., the one or more optical elements 660 have a transmittance of at least 15%, 20%, 25%, 30%, 35%, 40%, 45%, 50%, 55%, or 50%), which allows transmission of ambient light. In such embodiments, computer-generated images projected by electronic display 615 are superimposed with the transmitted ambient light (e.g., transmitted ambient image) to provide augmented reality images. In some embodiments, optical elements 660 include optical gratings described herein.

Input interface 640 is a device that allows a user to send action requests to console 610. An action request is a request to perform a particular action. For example, an action request may be to start or end an application or to perform a particular action within the application. Input interface 640 may include one or more input devices. Example input devices include: a keyboard, a mouse, a game controller, data from brain signals, data from other parts of the human body, or any other suitable device for receiving action requests and communicating the received action requests to console 610. An action request received by input interface 640 is communicated to console 610, which performs an action corresponding to the action request. In some embodiments, input interface 640 may provide haptic feedback to the user in accordance with instructions received from console 610. For example, haptic feedback is provided when an action request is received, or console 610 communicates instructions to input interface 640 causing input interface 640 to generate haptic feedback when console 610 performs an action.

Console 610 provides media to display device 605 for presentation to the user in accordance with information received from one or more of: imaging device 635, display device 605, and input interface 640. In the example shown in FIG. 6, console 610 includes application store 645, tracking module 650, and application engine 655. Some embodiments of console 610 have different modules than those described in conjunction with FIG. 6. Similarly, the functions further described herein may be distributed among components of console 610 in a different manner than is described here.

When application store 645 is included in console 610, application store 645 stores one or more applications for execution by console 610. An application is a group of instructions, that when executed by a processor, is used for generating content for presentation to the user. Content generated by the processor based on an application may be in response to inputs received from the user via movement of display device 605 or input interface 640. Examples of applications include: gaming applications, conferencing applications, video playback application, or other suitable applications.

When tracking module 650 is included in console 610, tracking module 650 calibrates system 600 using one or more calibration parameters and may adjust one or more calibration parameters to reduce error in determination of the position of display device 605. For example, tracking module 650 adjusts the focus of imaging device 635 to obtain a more accurate position for observed locators on display device 605. Moreover, calibration performed by tracking module 650 also accounts for information received from IMU 630. Additionally, if tracking of display device 605 is lost (e.g., imaging device 635 loses line of sight of at least a threshold number of locators 620), tracking module 650 re-calibrates some or all of system 600.

In some embodiments, tracking module 650 tracks movements of display device 605 using second calibration data from imaging device 635. For example, tracking module 650 determines positions of a reference point of display device 605 using observed locators from the second calibration data and a model of display device 605. In some embodiments, tracking module 650 also determines positions of a reference point of display device 605 using position information from the first calibration data. Additionally, in some embodiments, tracking module 650 may use portions of the first calibration data, the second calibration data, or some combination thereof, to predict a future location of display device 605. Tracking module 650 provides the estimated or predicted future position of display device 605 to application engine 655.

Application engine 655 executes applications within system 600 and receives position information, acceleration information, velocity information, predicted future positions, or some combination thereof of display device 605 from tracking module 650. Based on the received information, application engine 655 determines content to provide to display device 605 for presentation to the user. For example, if the received information indicates that the user has looked to the left, application engine 655 generates content for display device 605 that mirrors the user's movement in an augmented environment. Additionally, application engine 655 performs an action within an application executing on console 610 in response to an action request received from input interface 640 and provides feedback to the user that the action was performed. The provided feedback may be visual or audible feedback via display device 605 or haptic feedback via input interface 640.

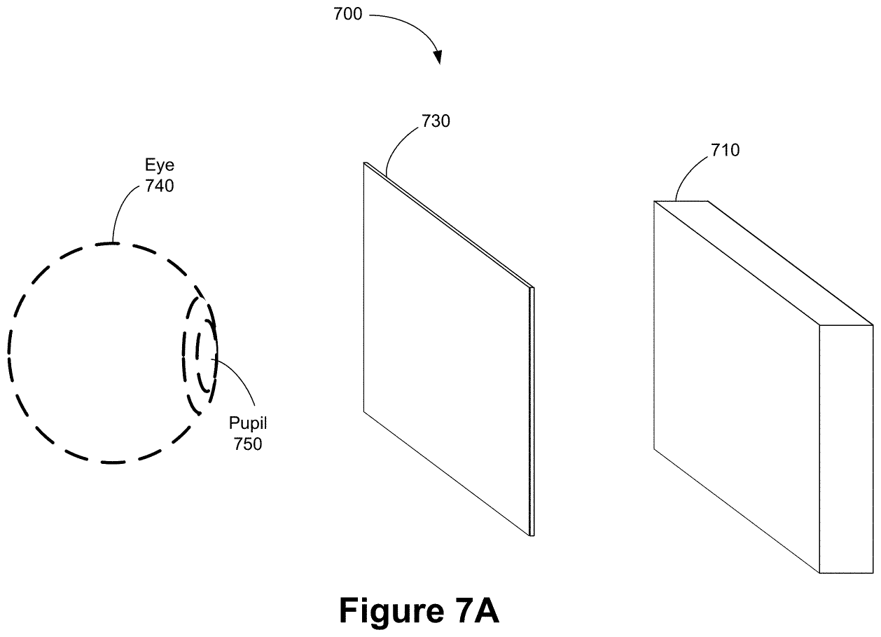

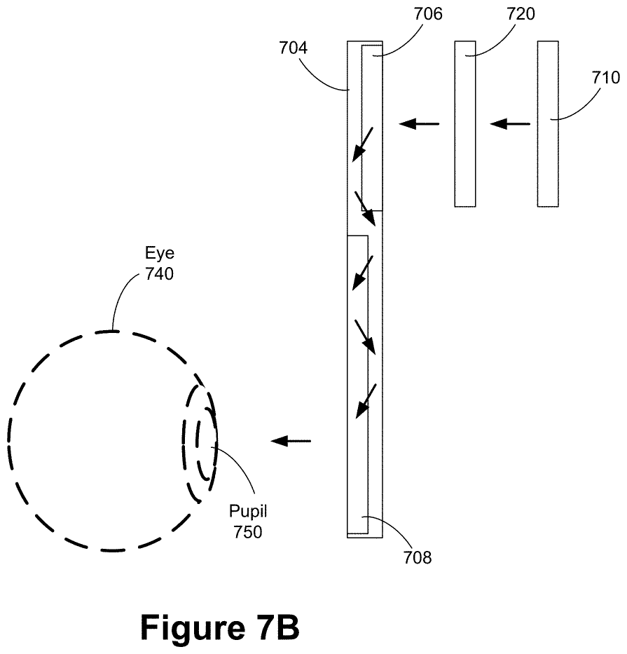

FIG. 7A is an isometric view of display device 700 in accordance with some embodiments. In some other embodiments, display device 700 is part of some other electronic display (e.g., a digital microscope, a head-mounted display device, etc.). In some embodiments, display device 700 includes light emission device 710 (e.g., a light emission device array) and an optical assembly 730, which may include one or more lenses and/or other optical components. In some embodiments, optical assembly 730 includes an optical grating having a non-uniform refractive index difference profile, as described herein. In some embodiments, display device 700 also includes an IR detector array.

Light emission device 710 emits image light and optional IR light toward the viewing user. Light emission device 710 includes one or more light emission components that emit light in the visible light (and optionally includes components that emit light in the IR). Light emission device 710 may include, e.g., an array of LEDs, an array of microLEDs, an array of organic LEDs (OLEDs), an array of superluminescent LEDs (sLEDS) or some combination thereof.

In some embodiments, light emission device 710 includes an emission intensity array (e.g., a spatial light modulator) configured to selectively attenuate light emitted from light emission device 710. In some embodiments, the emission intensity array is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to no attenuation, while other liquid crystal cells may be set to maximum attenuation. In this manner, the emission intensity array is able to provide image light and/or control what portion of the image light is passed to the optical assembly 730. In some embodiments, display device 700 uses the emission intensity array to facilitate providing image light to a location of pupil 750 of eye 740 of a user, and minimize the amount of image light provided to other areas in the eyebox. In some embodiments, display device 700 includes, or is optically coupled with, an optical assembly (e.g., one or more lenses, prisms, mirrors, filters, etc.). In some embodiments, display device 700 is an augmented reality display device. In such embodiments, display device 700 includes, or is optically coupled with, an optical grating having a non-uniform refractive index difference profile, as part of a waveguide-based combiner.

The optical assembly 730 includes one or more lenses. The one or more lenses in optical assembly 730 receive modified image light (e.g., attenuated light) from light emission device 710, and direct the modified image light to a location of pupil 750. The optical assembly 730 may include additional optical components, such as color filters, mirrors, etc. In some embodiments, optical assembly 730 includes an optical grating having a non-uniform refractive index difference profile, as described herein.

An optional IR detector array detects IR light that has been retro-reflected from the retina of eye 740, a cornea of eye 740, a crystalline lens of eye 740, or some combination thereof. The IR detector array includes either a single IR sensor or a plurality of IR sensitive detectors (e.g., photodiodes). In some embodiments, the IR detector array is separate from light emission device 710. In some embodiments, the IR detector array is integrated into light emission device 710.

In some embodiments, light emission device 710 including an emission intensity array make up a display element. Alternatively, the display element includes light emission device 710 (e.g., when light emission device 710 includes individually adjustable pixels) without the emission intensity array. In some embodiments, the display element additionally includes the IR array. In some embodiments, in response to a determined location of pupil 750, the display element adjusts the emitted image light such that the light output by the display element is refracted by one or more lenses toward the determined location of pupil 750, and not toward other locations in the eyebox.

In some embodiments, display device 700 includes one or more broadband sources (e.g., one or more white LEDs) coupled with a plurality of color filters, in addition to, or instead of, light emission device 710.

FIG. 7B is a schematic diagram illustrating a display device in accordance with some embodiments.

The display device includes display 710 for providing an image light, and in some configurations, an optical grating having a non-uniform refractive index difference profile positioned to receive the image light from display 710 and project the image light.

In FIG. 7B, the image light (from display 710) is directed to one or more optics 720 (e.g., lens), and to optical waveguide 704. The optical waveguide 704 includes optical gratings 706 and 708 for in-coupling and out-coupling of light. Light emitted from the optical waveguide 704 is transmitted toward a pupil 750 of an eye 740.

In some embodiments, the optical gratings 706 and 708 have non-uniform refractive index difference in the thickness direction (e.g., optical gratings have been processed by the methods described herein). Thus, optical gratings 706 and 708 have reduced side peaks in the grating efficiency curve so cross talk between optical gratings 706 and 708 is suppressed, thereby reducing optical artifacts in the projected image.

Although various drawings illustrate operations of particular components or particular groups of components with respect to one eye, a person having ordinary skill in the art would understand that analogous operations can be performed with respect to the other eye or both eyes. For brevity, such details are not repeated herein.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

What we claimed is:

1. A formulation for inkjet printing, comprising:
one or more solvents;
a plurality of nanoparticles having a first refractive index; and
a resin having a second refractive index ranging from 1.45 to 1.8, wherein the first refractive index is greater than the second refractive index.

2. The formulation of claim 1, wherein a coating made of the formulation has a refractive index greater than 1.9 and an optical loss less than 1%.

3. The formulation of claim 1, wherein the plurality of nanoparticles has functional ligands cross-linkable with the resin.

4. The formulation of claim 3, wherein the functional ligands are selected from a group consisting of epoxy, acrylate, vinyl, thiol, phenol, and hydroxyl.

5. The formulation of claim 1, wherein the second refractive index ranges from 1.6 to 1.8.

6. The formulation of claim 1, wherein the resin includes one or more of: an electromagnetic radiation-sensitive material, a light-sensitive material, or a heat-sensitive material.

7. The formulation of claim 6, wherein the resin further includes one or more of a thermal radical initiator, a thermal acid generator, a photo radical generator, and a photo acid generator.

8. The formulation of claim 1, wherein the resin includes one or more of: monomers or polymers.

9. The formulation of claim 1, wherein the plurality of nanoparticles includes titanium oxide nanoparticles.

10. The formulation of claim 1, wherein the one or more solvents include at least one solvent having a boiling point above 150° Celsius or a vapor pressure below 2.8 mmHg at 20° Celsius.

11. The formulation of claim 10, wherein the one or more solvents are selected from a group consisting of: propylene glycol methyl ether acetate, anisole, cyclohexanone, propylene carbonate, di(propylene glycol) butyl ether, di(propylene glycol) methyl ether, di(propylene glycol) dimethyl ether, di(propylene glycol) methyl ether acetate, butyl lactate, 2-ethylhexyl-lactate, benzyl benzoate, N-methyl-2-pyrrolidinone, gamma-butyrolactone, tripropylene glycol methylether, 1,6-diacetoxyhexane, 3-phenoxy toluene, benzyl alcohol, tolyl ether, and tripropylene glycol dimethyl ether.

12. The formulation of claim 1, further including one or more additives, a respective additive of the one or more additives including one or more monomers and/or polymers containing phosphonic acid or one or more aromatic groups with a hydroxyl, acid, alkyl ether, or alkyl ester functional group.

13. The formulation of claim 12, wherein the one or more additives include an additive selected from a group consisting of: poly(4-vinylphenol), poly(acetoxystyrene), poly(methoxystyrene), poly(di-acetoxystyrene), poly(di-methoxystyrene), cresol novolac, catechol novolac, phthalic acid, 3-methylcatechol, caffeic acid, eugenol, and vinyl-phosphonic acid.

14. The formulation of claim 1, wherein the formulation has a viscosity ranging from 2 to 16 cP.

15. The formulation of claim 1, wherein the formulation has a surface tension ranging from 20 to 50 Dynes/cm.

16. The formulation of claim 1, wherein a percentage of a solid material in the formulation ranges from 0.1% to 60%.

17. A method, comprising:
depositing a first amount of the formulation of claim 1 through one or more inkjet nozzles onto a first portion of a substrate having a non-flat surface and a second amount of the formulation through the one or more inkjet nozzles onto a second portion of the substrate having the non-flat surface, wherein the first amount of the formulation is distinct from the second amount of the formulation and the first portion of the non-flat surface is distinct from the second portion of the non-flat surface.

18. The method of claim 17, wherein:
depositing the first amount of the formulation and the second amount of the formulation thereby forms a coating of the formulation having a first surface conforming to the non-flat surface of the substrate and a second surface, opposite to the first surface, being a flat surface.

19. The method of claim 17, wherein the substrate is selected from a group consisting of TiOx, Si, SiOx, SiN, NbO, SiC, LiNbO3, and glass.

20. An optical device, comprising:
a surface relief grating; and
a coating layer having a refractive index higher than 1.9 disposed on the surface relief grating, the coating layer including:
a plurality of nanoparticles having a first refractive index; and
a resin having a second refractive index ranging from 1.45 to 1.8, wherein the first refractive index is greater than the second refractive index and the plurality of nanoparticles has functional ligands cross-linked with the resin.
